(19) United States
(12) Patent Application Publication
(10) Pub. No.: US 2008/0060621 A1
(43) Pub. Date: Mar. 13, 2008

(54) Heated fuel injector for cold starting of ethanol-fueled engines

(76) Inventors: David J. Trapasso, Bloomfield, NY (US); Murri H. Decker, Phelps, NY (US); Arthur R. Williams, Spencerport, NY (US)

Correspondence Address: DELPHI TECHNOLOGIES, INC., M/C 480-410-202, PO BOX 5052, TROY, MI, 48007, US

(21) Appl. No.: 11/520,347

(22) Filed: Sep. 13, 2006

(51) Int. Cl. F02G 5/00

(52) U.S. Cl. 123/557

(57) ABSTRACT

A fuel injector for heating fuel to be injected into an internal combustion engine. A cylindrical barrel extends between a solenoid and an injection tip for passage of fuel. The outer surface of the barrel supports a suitable circuit pattern formed of an electrically resistive material for generating heat which is passed through the wall of the barrel to warm the fuel which may be stationary or flowing. The electrically resistive material has a positive thermal coefficient, permitting voltage to be applied continuously across the heater causing a current to flow through the heater, the current being inversely proportional to the temperature of the heater. Thus, the heater is self-regulating, the current automatically increasing under cold conditions and diminishing as the fuel injector warms up after starting of the engine. Desirably, the heater is outside both the engine firing chamber and the flow path of the fuel.

### TECHNICAL FIELD

The present invention relates to methods and apparatus for starting internal combustion engines; more particularly, to such means for starting engines fueled in part or in whole by alcohols such as ethanol; and most particularly, to an improved fuel injector for such engines having an externally-heated barrel.

### BACKGROUND OF THE INVENTION

Fuel-injected internal combustion engines fueled in part or in whole by alcohols such as ethanol, methanol, and the like are well known. As used herein, the term “alcohol” is taken to mean all such forms of alcohol fuels and alcohol/alkane blends.

A known problem with fueling internal combustion engines with alcohol fuels is a relatively high fuel flash point as compared to octane or other alkane fuels, making starting under cold conditions difficult or impossible. For example, ethanol has a vaporization point of about 12° C., meaning that ethanol vapor below that temperature may cease to burn when a source of ignition is removed. The practical result is that, for vehicles and engines to be operated on alcohol in relatively cold climates, some enhancement of the fuel supply system is required to ensure that the engine can be started at temperatures below about 18° C., depending upon the percentage of alcohol in the alkane fuel supplied to the engine.

In engines fueled fully by alcohol and which must be operated in a cold environment, it is known to provide a small reservoir of gasoline and a system for injecting small amounts of gasoline into the engine in order to start it and to bring the engine temperature above the alcohol flash point. Such a device, although effective, can be undesirable for adding cost to the manufacture of an engine and vehicle and for requiring gasoline for operation, however brief.

U.S. Pat. No. 5,119,794 to Kushida et al. discloses a positive temperature coefficient (PTC) resistance heater block mounted on an inner wall of a gas passage such as an engine intake manifold or manifold runner. The heater block has branched fuel passages through which a liquid fuel is supplied and then vaporized by the heat of the heater so as to inject vaporized fuel from the openings of respective passages in the heater block. This vaporized fuel gas is joined to a liquid fuel gas injected by a fuel injector. Therefore, even if the fuel applied contains alcohol, the heater can efficiently heat the fuel without being influenced by the heat of vaporization of the alcohol so as to assist the atomization of the fuel.

Disadvantages of this prior art are that it is useful in only manifold-injected engines and not port-injected engines, since it is downstream of the fuel injector; its presence in the manifold can cause an air flow restriction; and it adds a further component, and therefore expense and complexity, to an engine.

U.S. Pat. No. 5,361,990 to Pimental discloses a PTC heater assembly applied to the extended tip of a fuel injector within an engine firing chamber. A plurality of self-regulating electrical resistance heater elements are secured to the outer surface of the fuel injector tip in sequence extending around the nozzle tip, and means are connected to the elements for connecting the elements to a power source for energizing the heaters to heat the fuel injector tip to heat the fuel just before it enters the firing chamber.

Two disadvantages of this prior art are that it requires an elongated fuel injector tip extending relatively far into the firing chamber, in comparison to standard prior art tips, which can create problems in positioning and actions of valves and the piston in the firing chamber and can adversely affect the fuel discharge pattern of the injector; and it requires that the heating elements, which are electrical components, be exposed to the extreme thermal, pressure, and percussive environment of a firing chamber.

U.S. Pat. No. 5,609,297 to Gladigow et al. discloses an atomization device that is fitted or attached directly onto a nozzle tip of a fuel injector. Fuel to be atomized flows longitudinally through the device in direct contact with vaporizer baffles and electrically-powered PTC heating elements and is discharged therefrom into the firing chamber.

Some disadvantages of this invention are that, as in the just-discussed invention, the device extends relatively far into the firing chamber, in comparison to standard prior art tips. Its stated purpose is to vaporize gasoline for cold start emissions reduction, not to alleviate an alcohol cold-start problem by warming the alcohol without vaporization.

Further, it is an auxiliary fuel atomizer and thus adds to the size, cost, and complexity of a fuel injector.

Still further, the PTC electrical components are in full contact with fuel, which during steady state engine operation is a hot and potentially corrosive environment. As noted in U.S. Pat. No. 5,758,826, direct exposure of the PTC material and the electrical connections to the fuel supply can possibly cause fouling of the surfaces, degrading the performance of the unit and/or loss of the electrical connection.

Still further, the patent purports that the device does not alter the injection spray pattern, but this cannot be so, because the spray pattern of a fuel injector is controlled by a director plate within the valve of the fuel injector, and the director plate of a fuel injector equipped with this device is masked by the device.

U.S. Pat. No. 5,758,826 to Nines discloses an internal heater for a fuel injector barrel including an array of plates of PTC material arranged about the valve element in a square tube shape, and surrounded by a heat insulating polytetrafluroethylene sleeve. The plates are preferably coated with polyimide to be protected from the fuel which flows over both surfaces of the plates. Electrical connections are established by inner and outer bands attached to the plates, with a conductive disc having tabs extending to the bands. Spring-loaded contact pins located radially outward from a seal on the side have wires extending to the connector body contacts of the injector.

Disadvantages of this invention are that it includes spring-loaded pins, seals, coating, insulators, adhesives and other materials in contact with fuel in a hot, wet, and potentially corrosive environment. The limited space available within the injector tip severely limits the amount of power that can be brought to bear in heating the fuel. The fuel injector is significantly more complex and therefore more difficult and expensive to manufacture than a comparable unit having an external heater, such as is disclosed in U.S. Pat. No. 5,361,990, discussed above.

What is needed in the art is a simple fuel injector system for an internal combustion engine wherein alcohol-based or other fuels may be heated without vaporization, reliably, economically, safely, and efficiently, prior to injection of the fuels into the engine firing chamber or intake manifold.

It is a principal object of the present invention to assure reliable starting of an internal combustion engine when fueled with an alcohol-based fuel when ambient temperatures are below the flash point of the fuel.

### SUMMARY OF THE INVENTION

Briefly described, an improved fuel injector for an internal combustion engine includes a generally cylindrical barrel extending between an actuating solenoid and a dispersal injection tip for passage of fuel between an injector inlet and the dispersal tip. A portion of the outer wall of the barrel is supportive of a heater formed of an electrically resistive material such that, when electric current is passed through the material, heat is generated which is passed through the wall of the barrel to warm the fuel resident therein. The fuel may be stationary or flowing. The heater may be formed in a helical strip coaxial with the barrel, or any other suitable pattern. Preferably, the electrically resistive material has a positive thermal coefficient which permits a voltage to be applied continuously across the heater causing a current to flow through the heater, the current being inversely proportional to the temperature of the heater. Thus, in an aspect of the invention, the heater is self-regulating, the current automatically increasing under cold conditions and diminishing as the fuel injector warms up after starting of the engine. Being on the outer wall of the fuel injector and ahead of the injector tip, the heater is outside both the engine firing chamber and the flow path of the fuel.

### BRIEF DESCRIPTION OF THE DRAWINGS

The present invention will now be described, by way of example, with reference to the accompanying drawings, in which:

FIG. 1 is a schematic cross-sectional drawing of a fuel injector in accordance with the invention;

FIG. 2 is an enlarged and detailed view of a portion of the fuel injector shown in FIG. 1, taken in Circle 2 therein;

FIG. 3 is a schematic cross-sectional view of a fuel injector barrel taken in Circle 3 of FIG. 1, showing a heater formed in an exemplar helical pattern on the outer surface thereof;

FIG. 4 is an enlarged view taken in Circle 4 in FIG. 3; and

FIG. 5 is an elevational cross-sectional view of a fuel injector equipped with a heater in accordance with the invention.

The exemplification set out herein illustrates one preferred embodiment of the invention, in one form, and such exemplification is not to be construed as limiting the scope of the invention in any manner.

### DESCRIPTION OF THE PREFERRED EMBODIMENTS

Referring to FIG. 1, a schematic fuel injector 10 improved in accordance with the invention comprises an elongate body 12 including a cylindrical barrel portion 14 formed of metal, ceramic or plastic in known fashion, wall 15 of barrel portion 14 extending longitudinally and terminating in valve seat 18. An armature valve assembly 20 including injector valve 16 is slidably resident in body 12 and is driven axially by a solenoid assembly 22 including a pole piece 24 and a magnetic coil 26. A seal ring 28 is provided at seat 18 for sealing injector 10 into a port in a firing chamber or an intake manifold of an internal combustion engine 30. Pressurized fuel 32 is supplied into injector 10 via fuel inlet 34. Energizing of solenoid assembly 22 causes valve 16 to be withdrawn from seat 18, allowing injection of pressurized fuel through seat 18 from chamber 36 within barrel portion 14. De-energizing of solenoid assembly 22 allows return spring 38 to reseat valve 16 against valve seat 18, terminating injection of fuel.

The elements and operation of a fuel injector as described thus far are well known in the prior art.

As discussed hereinabove, it is desirable in an internal combustion engine that the fuel being injected as a liquid for atomization and combustion be at a temperature at or above the flash point temperature for the fuel. This may require heating of fuel such as alcohol-based fuels from an ambient temperature as low as about −30° C. to as high as +120° C. at system fuel pressure, ethanol having a flashpoint of about +77° C. at ambient barometric pressure. The present invention provides a means to accomplish heating of a liquid fuel resident in chamber 36.

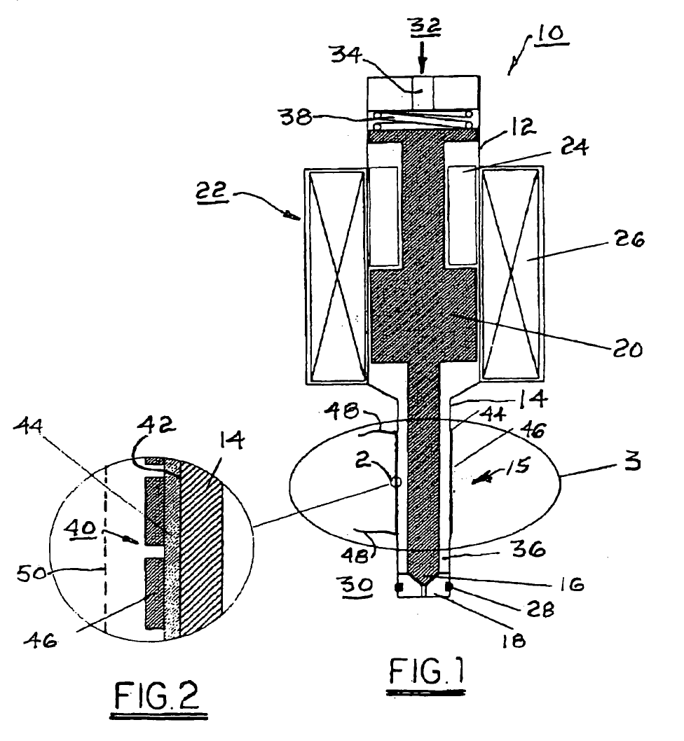

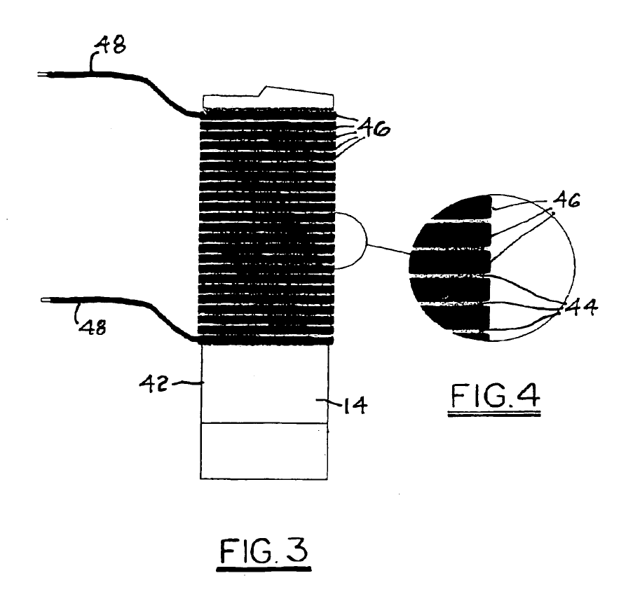

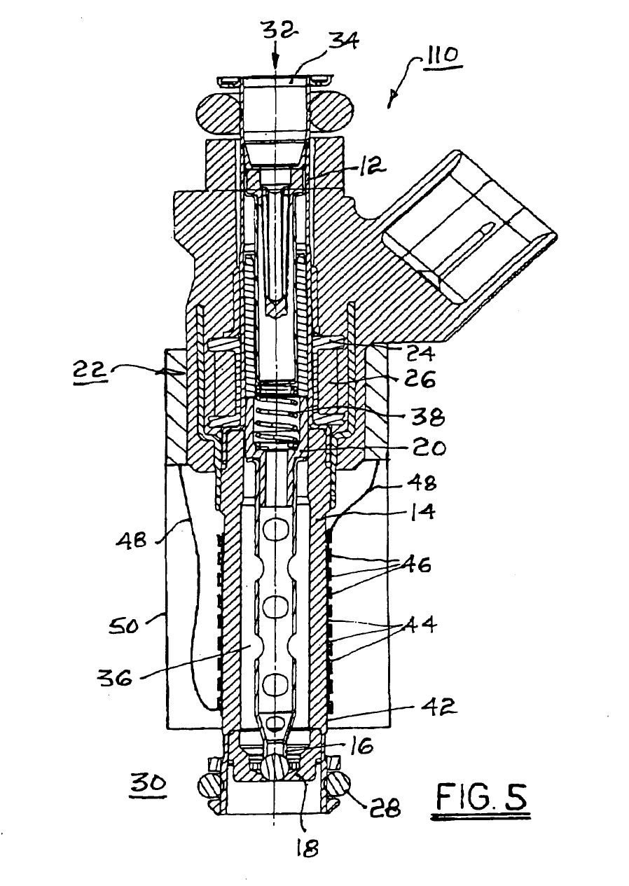

Referring now to FIGS. 1 through 4, a resistance heating assembly 40 is applied to the outer surface 42 of barrel portion 14, comprising a non-conductive ceramic substrate 44, preferably a continuous layer, overlain by a conductive heater element 46, helically formed of an electrically resistive material in contact with substrate 44 along a length of barrel portion 14. The material of heater element 46 has a relatively high electrical resistance and produces heat by the passage of electric current therethrough. Heat generated by element 46 is transferred by conduction through substrate 44 and the wall of barrel portion 14 to the fuel in chamber 36.

Heater element 46 may be formed, within the scope of the invention, by wrapping a cylindrical resistance heater wire (not shown) around substrate 44. However, such an embodiment has disadvantages because a cylindrical wire provides only line contact with substrate 44 and therefore provides relatively poor heat transfer into barrel 14. In an aspect of the invention, heater element 46 comprises a thick film of a ceramic resistance material, applied to wall 15 in any suitable circuit pattern having terminals at each end. The circuit pattern may be, for example, a helical strip with terminals at each end. A typical application process requires coating and/or printing of a plurality of layers followed by firing in a kiln, as is known in the art. Electrical leads 48 are attached to the ends of helical heater element 46 for supply of electricity through element 46 in known fashion.

Preferably, the ceramic material of heater element 46 has a positive temperature coefficient of electrical resistance such that resistance increases as temperature of the element increases. The advantage of a PTC heater element is that it is self-regulating: when current flows through the element, causing a temperature increase, the resistance increases, reducing the current, resulting in an equilibrium of temperature and current. As the element is dynamically cooled, as by passage of cool fuel into chamber 36, the heater is thereby cooled and automatically responds to generate more heat. If fuel flow through chamber 36 stops, as at engine shutdown, the heater element returns to its equilibrium temperature and current which preferably is above the vaporization point of the fuel. Thus, by proper selection of the thickness, width, and helix pitch of the film; thickness of the barrel wall; length of heater element; and heater element driving voltage, a fuel injector in accordance with the invention may be fabricated which automatically keeps a specific fuel such as alcohol heated above the fuel vaporization point even during periods of engine shutdown, permitting rapid and reliable starting of an alcohol-fueled engine even in cold climates. In severe conditions, it may be desirable to provide a thermally insulative jacket 50 over heater element 46 as a part of heater assembly 40. Of course, a heater assembly in accordance with the invention may be dynamically controlled by feedback or open control as desired.

Wall 15 of barrel portion 14 is desirably as thin as is safely practical for a port fuel injector, which may experience internal fuel pressures exceeding 100 bar. The thinner the barrel wall, the more rapid is the thermal response within chamber 36. For a stainless steel barrel, a currently preferred thickness is about 0.7 mm, which exhibits a thermal lag of about 0.7 second between heating on the outside and an equivalent temperature on the inside. It is understood that the barrel may be formed of a suitable material other than metal such as, for example, plastic or ceramic, in order to achieve the desired thermal response.

Referring now to FIG. 5, a fuel injector 110 in accordance with the invention includes components bearing the same numbers as are shown in FIGS. 1-3.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel injector having capability for heating fuel within the fuel injector, comprising:
a) a barrel for conveying fuel through a portion of said fuel injector to a valve seat terminating said barrel;
b) a resistance heating assembly disposed on an outer surface of said barrel,
wherein heat generated by passage of electricity through said resistance heating assembly is conductively transferred through a wall of said barrel to said fuel resident in said barrel.

2. A fuel injector in accordance with claim 1 wherein said resistance heating assembly includes an electrically-insulative substrate in contact with said barrel outer surface and a conductive heater element in contact with said electrically-insulative substrate.

3. A fuel injector in accordance with claim 2 wherein said conductive heater element is formed having a generally rectangular cross-sectional shape.

4. A fuel injector in accordance with claim 3 wherein said conductive heater element is formed in a circuit pattern.

5. A fuel injector in accordance with the claim 4 wherein said circuit pattern is a helix disposed coaxially with said barrel.

6. A fuel injector in accordance with claim 2 wherein said conductive heater element has a positive thermal coefficient of resistance.

7. A fuel injector in accordance with claim 1 wherein the thickness of said wall of said barrel supportive of said resistance heating assembly is about 0.7 mm.

8. A fuel injector in accordance with claim 1 wherein the flow status of said fuel resident in said barrel is selectable from the group consisting of flowing and stationary.

9. A fuel injector in accordance with claim 1 wherein said barrel is formed of a material selected from the group consisting of metal, ceramic and plastic.

10. A fuel injector in accordance with claim 9 wherein said material is a stainless steel.

11. A fuel injector in accordance with claim 1 wherein said fuel includes at least one alcohol compound.

12. A fuel injector in accordance with claim 11 wherein said alcohol compound is ethanol.

13. A fuel injector in accordance with claim 1 wherein said resistance heating element is capable of heating said fuel from an ambient temperature to a temperature above the flashpoint of said fuel.

14. A fuel injector in accordance with claim 13 wherein said ambient temperature is at least about −30° C.

15. A fuel injector in accordance with claim 1 adapted for a use selected from the group consisting of port-injection and manifold-injection.

16. An internal combustion engine comprising a fuel injector having capability for heating fuel within said fuel injector, wherein said fuel injector includes
a barrel for conveying fuel through a portion of said fuel injector to a valve seat terminating said barrel, and
a resistance heating assembly disposed on an outer surface of said barrel,
wherein heat generated by passage of electricity through said resistance heating assembly is conductively transferred through a wall of said barrel to said fuel resident in said barrel.
